(19) United States
(12) Patent Application Publication
(10) Pub. No.: US 2021/0282994 A1
(43) Pub. Date: Sep. 16, 2021

(54) ASSISTANT FOR STABILIZING, MOBILIZING AND SECURING A PATIENT

(71) Applicant: ASP GmbH, Attendorn (DE)

(72) Inventor: Stefan LÖCKER, Finnentrop (DE)

(73) Assignee: ASP GmbH, Attendorn (DE)

(21) Appl. No.: 17/274,811

(22) PCT Filed: Sep. 9, 2019
(86) PCT No.: PCT/EP2019/073924

§ 371 Date: Mar. 10, 2021

(30) Foreign Application Priority Data
Sep. 12, 2018 (DE) 10 2018 215 529.1

(51) Int. Cl. A61G 7/10

(52) U.S. Cl. CPC A61G 7/1046; A61G 7/1007; A61G 7/1019; A61G 7/1092; A61G 7/1084; A61G 7/1088; A61G 7/1059

(57) ABSTRACT

An assistant apparatus (1, 100) for mobilizing a patient includes a seat (5) for receiving the patient. The seat (5) is attached to the side of a mast of a trolley (3) that is mounted on rollers (2). The seat (5) comprises a seat surface (6), a backrest (7) and armrests (8).

### TECHNICAL FIELD

The invention relates to an assistant for stabilizing, mobilizing, and securing a patient.

### BACKGROUND

The so-called patient mobilization is part of the daily therapy applications and treatments in nursing and patient care in hospitals, in nursing care for elderly and disabled persons, as well as in the field of rehabilitation. In order to be able to carry out the physiotherapy movement exercises, cardiovascular training, and breathing training that are necessary for patient mobilization, patients must often be mobilized from a lying position in the patient's bed to the sitting position. Particular attention must be paid to the safety of the patient, as the often weakened, injured or otherwise disabled patients cannot take a stable sitting position on their own. To avoid accidents, patients must be supported or secured in a sitting position while the patient is being mobilized. Many patients can be brought not only into a sitting position from the edge of the bed. In many cases, it is also possible for patients to be stabilized in a standing position.

In many cases, caregivers or physiotherapists have to lift the often obese patients out of bed and, for example, place them in special, often extra-wide wheelchairs or the like, in order to carry out mobilization exercises as well as cardiovascular training and breathing training while the patient is sitting. There are known seating aids that can be installed on the patient's bed, so that the person to be cared for does not have to be lifted out of bed and is adequately supported and secured in the sitting position in bed or on the edge of the bed.

DE 102 27 273 A1 discloses a seating aid consisting of armrests, backrest and tabletop, wherein the individual parts can be connected to each other and to the bed frame via plug connections. The seating aid specified here allows a patient to sit on the side of the bed, while adequately supporting and securing the patient.

An alternative device for securing the sitting position of a patient sitting on the edge of a bed is described in DE 20 2007 010 738 U1, wherein a substantially rectangular retaining bracket can be detachably connected to the frame of the bed via fastening means. The retaining bracket of the device is pivotally mounted on the fastening means, so that by means of a simple pivoting movement over the head of a patient that is sitting on the edge of the bed, the retaining bracket can be guided to the patient's chest area and thus secure the patient adequately.

DE 10 2011 052 839 A1 discloses a seating aid for patient beds that can be attached to a bed frame, which has at least one support element that can be detachably connected to the bed frame, a main axis, at least two armrests arranged on the support element, as well as at least one backrest arranged between the armrests on the support element. The armrests and the backrest can be placed independently of each other along the main axis of the support element and fastened to the support element with the aid of a fastening means.

The independently positionable arrangement of the backrest and the armrests on the support element is intended to offer the possibility to adapt the seating aid to the individual patient's body size and needs. The positionable backrest can be attached to the support element in any desired position.

DE 10 2015 118 955 A1 discloses an assistant for mobilizing patients with a support element that is to be placed on a bed and a backrest, wherein the support element comprises a first longitudinal element and a second longitudinal element which is laterally offset from the first longitudinal element, wherein the backrest has a frame structure which is connected to one end on the first and second longitudinal elements, and wherein the first and/or second longitudinal element can be fixed to a bed edge of the bed.

### SUMMARY

It is an object of the present disclosure to provide an assistant for stabilizing, mobilizing, and securing, which enables patients to be easily mobilized from a lying position into the assisted sitting or standing position while at the same time being easy to use by caregivers.

This object is achieved by the assistant apparatus as claimed.

Bedridden patients should be mobilized into the sitting position as early as possible, preferably also be mobilized into the standing position, especially at the edge of the bed to effectively promote their participation, to shorten ventilation times, to accelerate the recovery of everyday functions, as well as, in the sense of early mobilization, to prevent negative effects of immobility such as pulmonary, dermatological, neuromuscular, psychiatric, and cognitive complications.

The disclosed assistant apparatus is mainly designed to enable a patient to sit down, but it also enables a patient to stand up with its help, which happens especially at the edge of the bed, but is not limited to the edge of the bed as it can also be done from any sitting position, such as from an ordinary chair or from a toilet seat.

Consequently, the patient benefits from the use of the assistant apparatus in two ways: The negative effects of immobility listed above are reduced. Mobilizing a patient as early as possible has a positive and healing effect on the patient's alertness and participation, shorter ventilation times and faster regaining of independence. In addition, the patient's recovery process is optimally supported by early mobilization. Thus, the risk of complications arising from a patient being bedridden and immobile is significantly reduced.

In addition to these advantages for the patient, the assistant apparatus also helps the caregiver. Without an assistant apparatus, another person must support the patient in the assisted seat for the entire duration of the sitting. Finally, the time and effort saved by the caregiver and the expected faster patient throughput due to the shortened stay of the individual patient in the ward results in potential financial benefits for the clinic.

Therefore, an assistant apparatus is created which has a straightforward construction method that can be easily operated by caregivers and can also be used in intensive care units.

The assistant apparatus supports the patient on all sides, insofar as this is necessary in the respective case, and at the same time allows various forms of mobilization of the patient, for example the upper body, arms, legs, shoulders, head, etc.

The assistant apparatus thus provides a technical aid that enables a patient to be mobilized at the edge of the bed. The assistant apparatus can therefore be used both for the outpatient department and for early mobilization in intensive care units as well as for long-term care in nursing homes, institutions for the disabled, and home care settings. The assistant apparatus can also be used in narrow patient rooms by utilizing the space efficiently, since the seat attached to the assistant apparatus can be conveniently placed in a position at bed height and lying height of the patient by adjusting the height of the seat accordingly and placing it in the position where the patient is pivoted.

Through these possible uses, the assistant apparatus helps to strengthen the muscles of the musculoskeletal system, to improve cardiovascular training, to improve breathing training, for pneumonia prophylaxis, i.e., to prevent pneumonia, to strengthen the perception of a patient, to change the visual environment, to train a physiologically desirable sitting position, to shorten the stay in an intensive care unit, or the total hospital stay. The elimination of the need to transfer the patient out of bed through many movements, as well as the presence of supports and retaining straps, improve the safety of the patient. The mobilization of those in the most need of care is also made possible. A comfortable sitting position is achieved through the convenient adjustment of the backrest.

The individual adaptability to the patient's anatomical conditions ensures the best possible usability for all patients.

The workload of the caregiver is greatly reduced. Because there is no transfer from bed, the incidence of dislocations of the venous access, drainage, tubes, and other drains is reduced.

In emergency and resuscitation situations, no time is lost by repositioning the patient on the floor and/or transferring them back to bed, because the patient can be transported back directly from the assistant's seat to the lying position of the bed.

One embodiment that is particularly advantageous is that the seat is attached offset laterally with respect to the mast of the trolley and is connected to the trolley via at least one support arm. With this configuration of the assistant, the freedom of movement of the model is increased compared to the model described above. This model can easily be pushed to the side of the patient's bed.

It is also advantageous that, in this embodiment, the assistant apparatus has a lateral torque support that is arranged essentially below the seat and that is connected or connectable to the trolley, for example in the form of a further arm, which is arranged at least essentially below the support arm. The center of gravity of the patient's seat is directly above the point on which the torque support is supported relative to the ground. It is preferably provided that the torque support is also installed via at least one roller and can be moved together with the trolley.

It is particularly advantageous if the backrest also has at least one positioning means to adjust or change of an inclination of the upper body that is adapted to the patient.

In particular, the backrest can be pivoted and/or its height can be adjusted in relation to the seat surface.

Furthermore, the armrests are preferably each equipped with at least one positioning means.

In particular, the armrests are advantageously arranged to be pivotable and/or height-adjustable with respect to the seat surface.

Preferably the armrests can be adjusted in length.

In order to achieve an optimal adjustment to the individual arm length of the patient, it can be provided that the arm rests, each divided in two in the longitudinal direction, are designed as an upper arm support and a forearm support for the separate support of the patient's upper and forearm, wherein the upper arm rests and the forearm rests are each connected via pivot and swivel joints and are each individually adjustable in length.

The seat can also be equipped with at least one positioning means.

The seat surface can advantageously be inclined forwards with respect to the vertical axis. In addition, it can be provided that the seat surface can be inclined laterally with respect to the vertical axis. For example, if the patient has an inclined position of the pelvic ring in relation to the spine as a result of scoliosis, it can be corrected in an orthopedic manner in the sitting posture on the assistant's seat.

In an advantageous manner, instead of a mechanical drive for the seat, the backrest, and/or the armrests, a motorized drive can be provided for pivoting, rotating and/or lifting movements in all spatial directions for the mobilization of the patient. By means of motor-assisted alternating movements of the individual support means to support the patient, it is also possible to build up individual muscle groups of the patient, such as the arm flexors. The adjustment of the movements by the caregiver can easily be monitored from a control panel which is arranged, for example, on the mast of the assistant apparatus.

To increase the comfort of the patient or to place objects, such as a drinking vessel, at least one of the armrests can be equipped with a tray at its front end. The tray is also only suitable for resting one hand of the patient; a foldable design of the tray is also advantageous.

A vertical support can also advantageously be attached to the at least one tray, which can be held by the patient's hand.

In particular, a positioning means or a control stick, which can be operated by the patient and/or a caregiver, can be arranged on the tray for setting a sitting position, the backrest, the armrests, etc., of the patient.

Preferably, the seat comprises a headrest, which is arranged in such a way as to be adjustable in height and/or inclination, especially with respect to the backrest.

It is also advantageous to use footrests, which are particularly adjustable in height and/or inclination relative to the seat surface and, if necessary, can be pivoted away from the position in which the patient rests his feet on them when sitting.

In one embodiment of the invention, a toilet bucket can advantageously be attached underneath the seat, which is especially slidably connected to the seat in sliding strips that are attached below the seat surface and can be easily removed in this way.

To facilitate operation by the caregiver, operating means, especially an operating keyboard, are arranged on the trolley for the motorized adjustment of the seat. This can be part of a computer that is adapted especially to the intranet of a hospital, a care unit, etc. and is especially integrated into the assistant apparatus.

It is also advantageous if a monitor is arranged on the trolley for displaying settings made on the trolley, patient data and other information. With a digital online connection and, for example, with a special application software, many functions can be implemented such as localizing the assistant's whereabouts, the current use of the assistant, the display of maintenance work and intervals, automatic recording of operating data, error data, statistical analyzes of operating data relating to the device, the ward, the caregiver, etc.

Through a lifting aid function for a bedridden patient that can be implemented with the assistant apparatus, care work can be carried out by a single caregiver that would otherwise require at least two caregivers. The lifting aid function is best implemented when both the seat and the backrest of the assistant can be pushed out of the sitting position and the backrest can be brought into a horizontal position to accommodate the patient, while preferably the armrests are pivoted to the side.

If push handles are attached to the trolley, preferably to the mast of the assistant apparatus, for movement or to control and support a motorized movement of the trolley the assistant apparatus can be easily moved by the caregiver. A brake is preferably also provided on the trolley, especially a brake that can be operated by foot and is attached directly to at least one of the rollers.

Due to the ease of use, using the assistant apparatus also prevents the caregivers from developing back problems since the patients no longer need to be lifted by the caregiver.

The assistant apparatus can not only be used in the patient bed area, but also as a toilet chair, as a shower wheelchair or as a seat or bath lifter, in that only the area of the seat receiving the patient is rotated or pushed into the area that comes into contact with moisture or running water.

Furthermore, a belt system is preferably attached to the assistant apparatus, by which the patient is secured.

### BRIEF DESCRIPTION OF THE DRAWINGS

FIG. 1 shows a perspective view of a first assistant apparatus.

FIG. 2 shows the assistant apparatus according to FIG. 1 in a side view.

FIG. 3 shows the assistant apparatus according to FIG. 1 in a view from the front.

FIG. 4 shows the assistant apparatus according to FIG. 1 in a view from the rear.

FIG. 5 shows the assistant apparatus according to FIG. 1 in a top view.

FIG. 6 is a perspective view of a second assistant apparatus.

FIG. 7 shows the assistant apparatus according to FIG. 6 in a side view.

FIG. 8 shows the assistant apparatus according to FIG. 6 in a view from the front.

FIG. 9 shows the assistant apparatus according to FIG. 6 in a view from the rear.

FIG. 10 shows the assistant apparatus according to FIG. 6 in a top view.

### DETAILED DESCRIPTION

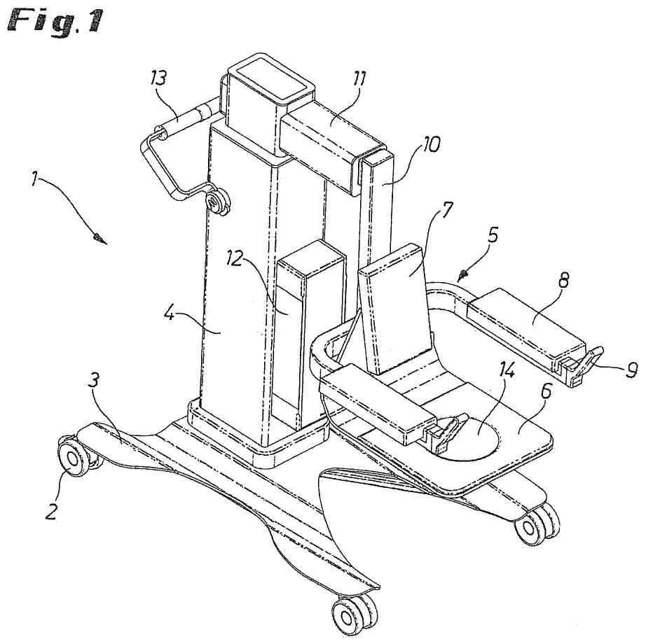

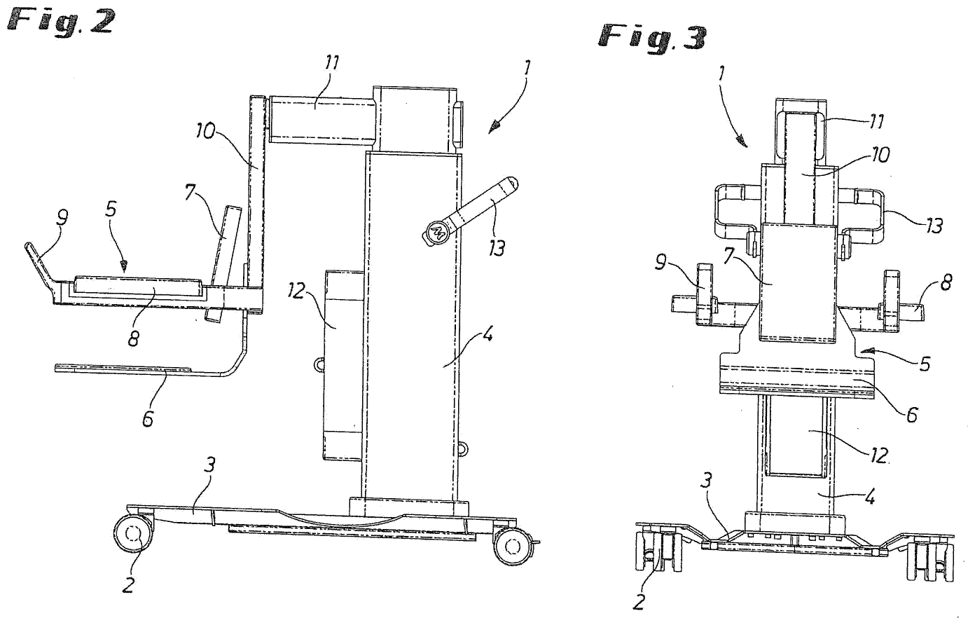

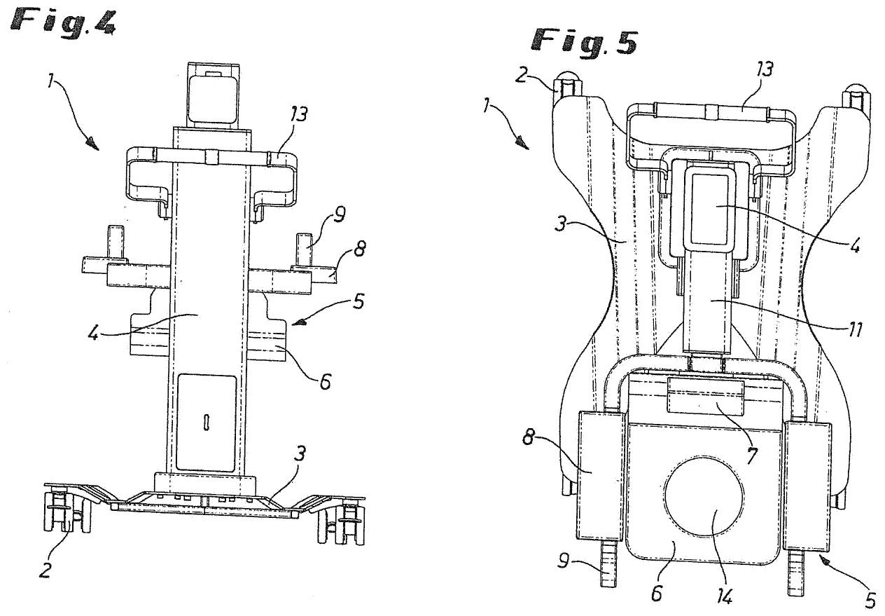

An assistant apparatus 1 (FIGS. 1 to 5) comprises a roller frame or a trolley 3 mounted on rollers 2, and a seat 5 attached to the front of a mast 4 for receiving a patient. The seat 5 comprises a seat surface 6, a backrest 7 and armrests 8.

On the front of the armrests 8 holding or support or operating handles 9 are attached, which can be used to enable the patient to adjust individual positions of the seat surface 6, the backrest 7, etc. if the adjustability function has been released for the patient by the caregiver. The handles 9 can also be used to stabilize a patient sitting, for example on the edge of the bed, in the standing position. In doing so, the patient holds the handles 9 from his seated position, with his face turned in the direction of the retaining strut 10. By adjusting the height of the seat 5, the patient, who is holding on to the handles 9, is supported in the attempt to stand up, because the handles 9 move upwards at the same time. It goes without saying that the design of the handles 9 and their inclination with respect to the vertical can be adapted to the shape and position of the patient's hands.

The seat 5 is connected to the mast 4 via a vertical retaining strut 10 and a horizontal retaining strut 11. The seat 5 is preferably motorized and adjustable in height relative to the mast 4. Operating means (not shown), a monitor and the like are preferably accommodated on the mast 4 or in a separate housing 12 attached to the mast 4. The assistant apparatus 1 can be moved or rotated by means of a push handle 13, wherein these movements are preferably supported by a motor. The seat surface 6 preferably has a recess 14 that can preferably be closed so that a toilet bucket can be inserted.

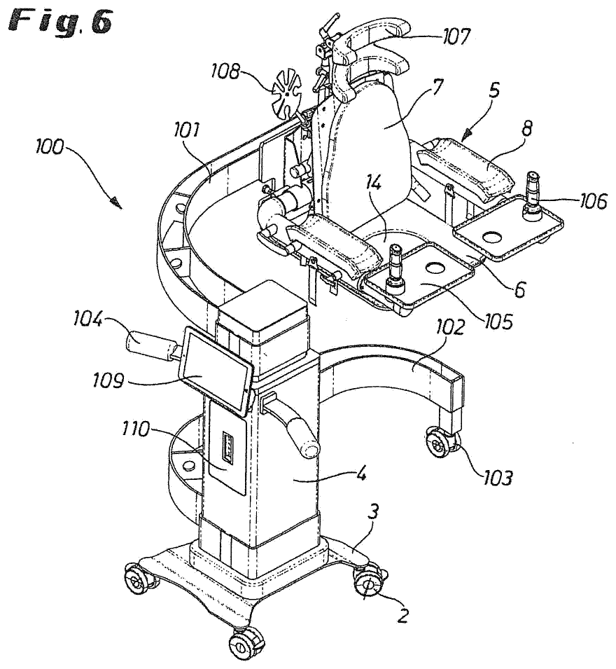

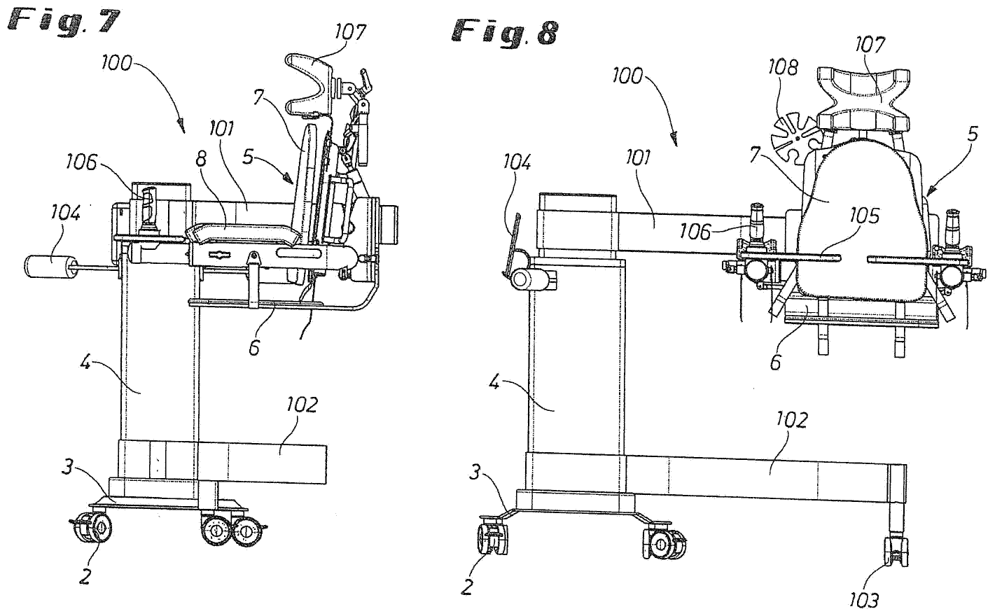

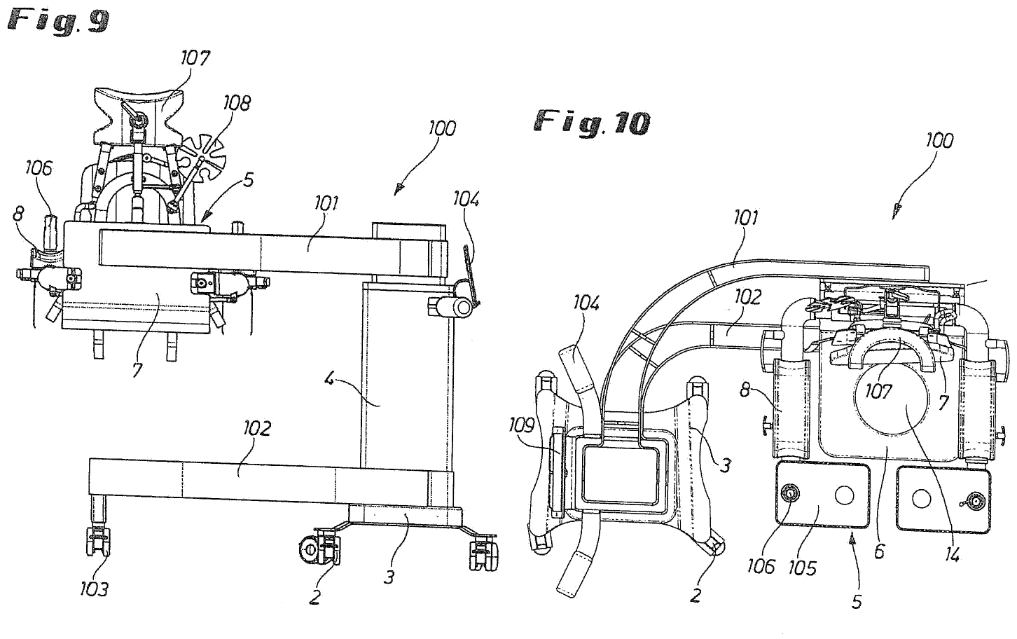

Insofar as a second assistant 100 (FIGS. 6 to 10) comprises the same components as the assistant apparatus 1, these are provided with the same reference symbols.

The assistant apparatus 100 additionally comprises a lateral support arm 101 which carries the seat 5. The seat 5 is arranged so that it can be adjusted in height either with respect to the support arm 101 or together with the support arm 101 with respect to the mast 4 of the assistant. It can also be provided that the support arm 101 can be pivoted relative to the mast 4 over a certain range, for example by 10°. Alternatively, the seat 5 is attached pivotably with respect to the support arm 101. All relative movements of the support arm 101 with respect to the mast 4 are realized by a motor, for example, by a motor arranged in the interior of the mast 4.

The support arm 101, along with the seat 5 attached to it, generates a lateral torque with respect to the trolley 3 and the mast 4. This torque is absorbed by a torque support 102, which is firmly connected to the rolling or trolley 3 and is supported on the floor via a roller 103, so that the assistant 100 as a whole is movable on the plane, wherein the mobility is being supported by side handles 104 that are attached to the mast 4. The roller 103 is preferably attached under the center of gravity of the unit formed by the seat 5 and the support arm 101, such that when the seat 5 is loaded with a patient of average weight, no lateral torque acts on the mast 4.

On the front side of the armrests 8, a tray 105, which can preferably be pivoted or folded away, is provided so that one hand of the patient can rest on it. A control stick 106 that can be held by one hand is preferably attached to each of the trays 105, which is used, for example as a joystick, to operate the assistant by the caregiver or—after appropriate approval—by the patient.

For more comfort, the seat 5 has a headrest 107 that can be pivoted and/or height-adjusted above the backrest 7. In the area behind the seat 5, there is a guide means 108 for guiding supply hoses, cables, and the like for supplying the patient or for recording patient data.

A monitor 109 is provided on the mast 4 to display data from the patient, the assistant apparatus 100 as well as other messages. An input keyboard, further input means such as a computer mouse and the like are preferably also provided in the area of the mast 4, wherein the input keyboard can be arranged on a panel 110 which can preferably be pivoted and arranged with respect to the mast 4.

Retaining straps are preferably provided for both assistant 1 and assistant 100, with which the patient is secured in relation to the seat surface 6 and/or in relation to the backrest 7 so that he does not injure himself or fall out of the seat 5.

As a further advantageous embodiment of the assistant 1, 100, a body weight scale, that is especially integrated in the seat 5, is provided in order to weigh the patient.

1.-25. (canceled)

26. An assistant apparatus (1, 100) for mobilizing a patient, comprising:
a trolley (3) mounted on rollers (2), wherein the trolley (3) includes a mast (4); and
a seat (5) for receiving the patient, the seat (5) being attached to a side of the mast (4), wherein the seat (5) includes
a seat surface (6),
a backrest (7), and
armrests (8).

27. The assistant apparatus (100) according to claim 26,
wherein the seat (5) is attached laterally offset with respect to the mast (4) of the trolley (3) and is connected to the trolley (3) via at least one support arm (101).

28. The assistant apparatus (100) according to claim 26,
further comprising a lateral torque support (102) which is arranged essentially below the seat (5) and which is connected to the trolley (3).

29. The assistant apparatus (100) according to claim 28,
wherein the torque support (102) is supported by at least one further roller (103) and moves with the trolley.

30. The assistant apparatus (1, 100) according to claim 26,
wherein the backrest (7) comprises at least one positioning mechanism.

31. The assistant apparatus (1, 100) according to claim 30,
wherein the backrest (7) is pivotable and/or height-adjustable relative to the seat surface (6).

32. The assistant apparatus (1, 100) according to claim 26,
wherein each of the armrests (8) comprises at least one positioning mechanism.

33. The assistant apparatus (1, 100) according to claim 32,
wherein the armrests (8) are pivotable and/or height-adjustable with respect to the seat surface (6).

34. The assistant apparatus (1, 100) according to claim 32,
wherein the armrests (8) are adjustable in length.

35. The assistant apparatus (1, 100) according to claim 32,
wherein the armrests (8) are each split in the longitudinal direction into
an upper arm support and
a forearm support
for the separate support of the patient's upper and forearm,
wherein the upper arm support and the forearm support are each connected via pivot and swivel joints and are each individually adjustable in length.

36. The assistant apparatus (1, 100) according to claim 26,
wherein the seat surface (6) comprises at least one positioning mechanism.

37. The assistant apparatus (1, 100) according to claim 36,
wherein the seat surface (6) can be inclined forwards with respect to the vertical axis.

38. The assistant apparatus (1, 100) according to claim 36,
wherein the seat surface (6) can be inclined laterally with respect to the vertical axis.

39. The assistant apparatus (1, 100) according to claim 26,
wherein the seat surface (6), the backrest and/or the armrests (8) are each equipped with a motor drive for pivoting, rotating and/or lifting movements in all spatial directions to mobilize the patient.

40. The assistant apparatus (1, 100) according to claim 26,
wherein at least one of the armrests (8) is equipped at its front end with a tray (105) for supporting a hand of the patient and/or an object, and
wherein the tray can be folded down.

41. The assistant apparatus (1, 100) according to claim 40,
wherein a vertical support is attached to the tray and configured to be held by the patient's hand.

42. The assistant apparatus (1, 100) according to claim 40,
wherein a positioning mechanism configured to be operated by the patient and/or a caregiver or a control stick (106) for setting a sitting position of the patient is arranged on the tray (105).

43. The assistant apparatus (1, 100) according to claim 26,
wherein the seat (5) comprises a headrest (107) which is arranged so as to be adjustable in height and/or inclination with respect to the backrest (7).

44. The assistant apparatus (1, 100) according to claim 26,
wherein the seat (5) comprises footrests, which are adjustable in height and/or inclination relative to the seat surface (6).

45. The assistant apparatus (1, 100) according to claim 26,
wherein a toilet bucket can be attached underneath the seat surface (6), the toilet bucket being connected to the seat (5) in a slidable manner held in sliding strips that are attached below the seat surface (6).

46. The assistant apparatus (1, 100) according to claim 26,
wherein an operating keyboard for motorized adjustment of the seat (5) is arranged on the trolley (3).

47. The assistant apparatus (1, 100) according to claim 26,
wherein a monitor (109) is arranged on the trolley (3) to display settings made on the trolley, patient data, and other information.

48. The assistant apparatus (1, 100) according to claim 26,
wherein push handles (13, 104) are attached on the mast (4) of the trolley (3) for moving or for controlling and supporting a motorized movement of the trolley (3).

49. The assistant apparatus (1, 100) according to claim 26,
wherein the trolley (3) is equipped with a brake.

50. The assistant apparatus (1, 100) according to claim 26,
further comprising a body weight scale integrated in the seat (5).
